(19) United States
(12) Patent Application Publication
(10) Pub. No.: US 2009/0132443 A1
(43) Pub. Date: May 21, 2009

(54) Methods and Devices for Analyzing Lipoproteins

(76) Inventors: Odilo Mueller, Santa Clara, CA (US); Thomas Ragg, Weingarten (DE)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/941,642

(22) Filed: Nov. 16, 2007

(51) Int. Cl. G06F 15/18; G06G 7/48; G06N 3/02

(52) U.S. Cl. 706/12; 703/11; 706/15; 706/14

(57) ABSTRACT

The disclosure describes methods, systems, and devices for analysis of lipoproteins and for diagnosing and/or determining risk of cardiovascular disease. In some embodiments, lipoproteins are separated by electrophoretically using a micro-channel device, and the data are analyzed using an adaptive method such as a neural network.

### BACKGROUND OF THE INVENTION

Cardiovascular disease has been correlated with a number of risk factors including age, body mass index, blood pressure, triglycerides, total cholesterol, LDL cholesterol, HDL cholesterol, Lipoprotein a, and fasting blood glucose.

High density lipoprotein (HDL) is a key component in cholesterol removal and is thought to be cardioprotective. In addition, it is attributed with anti-inflammatory, anti-infectious, and anti-oxidative properties as well as exhibiting anti-apoptotic and anti-thrombotic effects (Assmann et al., Ann Rev. Med. 54:321(2003)). HDL subclasses have been characterized by density, size and composition. The smaller, denser protein-enriched particles are classified as HDL 3 and include three major subclasses as defined by gradient gel electrophoresis (HDL 3c, HDL 3b and HDL 3a), while the larger less-dense lipid-enriched particles are designated HDL 2 and include two major subclasses (HDL 2a and HDL 2b). The relationship between any of the HDL sublcasses and cardiovascular disease has not been definitively established.

Low density lipoprotein (LDL) are also highly heterogeneous, including multiple subpopulations, although a single copy of apolipoprotein B-100 (apoB-100) predominates in the protein moiety of all LDL subclasses. On a physicochemical basis, LDL particles may be grouped into three major density subclasses: light, large LDL (LDL1, LDL2; density 1.018-1.030 g/ml), intermediate LDL (LDL3; density 1.030-1.040 g/ml), and small, dense LDL (LDL4, LDL5; density 1.040-1.065 g/ml). In primary hypercholesterolemia of type IIA, the elevated plasma concentrations of both light, large LDL (LDL1, LDL2), and LDL of intermediate density (LDL3) frequently predominate relative to those of small, dense LDL (LDL4, LDL5).

Structurally, Lipoprotein a (Lp(a)) is a complex macromolecule containing apolipoprotein B-100, the main lipoprotein of low density lipoprotein (LDL) particles and a carbohydrate-rich, highly hydrophilic protein, apolipoprotein (a) (apo(a)), in which one molecule of apo(a) is covalently linked to one lipoprotein B-100 component by a disulfide bridge (Koschinsky et al. Curr Opin Lipidol. (2004) 15:167-74; Guevara et al. Proteins (1992) 12:188-99). The apo(a) moiety is heterogeneous due to a high level of polymorphism. The current widely accepted method for the determination of serum Lp(a) level, immunochemical analysis, which applies antibodies against apo(a) portion of the Lp(a), cannot accurately and reproducibly assess Lp(a) level due to the highly heterogeneous nature of apo(a).

The methods used to detect lipoprotein subclasses have been labor intensive, expensive and lengthy. Traditionally, ultracentrifugation has been used to separate HDL and LDL sub-fractions by density, which is achieved by spinning the serum samples in density adjusted buffer solution for 16 to 24 hrs. After the time consuming separation process, subclasses need to be quantitated by optical methods or by using enzymatic methods. Other lipoprotein subfractionation methodologies have been developed including gradient gel electrophoresis, ion mobility measurements, capillary electrophoresis, and HPLC. (Hulley et al., J. Lipid Res. 12:420 (1971); Blanche et al., BBA 24:665(1981); Hu et al., J. Chromat. A. 24:717 (1995); Hara et al., J. Biochem. 87:1863 (1990)). However, their use has been limited because most of these require expert technical personnel for operation.

Thus, it would be desirable to provide methods and devices for analysis of lipoprotein subclasses in biological samples and to provide methods for determining risk of cardiovascular disease based on the lipoprotein subclasses.

### SUMMARY

The disclosure describes methods, systems, and devices for analysis of lipoproteins and for diagnosing and/or determining risk of cardiovascular disease.

Systems and methods comprise detecting a target analyte in a patient sample, analyzing the resulting data, and providing a diagnosis or risk assessment. In some embodiments, the target analyte is a class of lipoproteins. In some embodiments, the class of lipoproteins is selected from the group of HDL, LDL, Very Low Density Lipoprotein (VLDL), Lp(a) and combinations thereof. In some embodiments, the target analyte is one or more subclasses of a class of lipoproteins. In some embodiments, the subclasses are selected from the group consisting of subclasses of HDL, subclasses of LDL, subclasses of Lp(a) and combinations thereof. In some embodiments, the target analyte comprises HDL 2b.

The systems and methods include a separation device in combination with a reader, particularly a computer-assisted reader, and data processing software employing a risk assessment model. In some embodiments, the methods include performing a separation of a class of lipoproteins or separating a lipoprotein into subclasses from a sample from a subject, reading the data, and processing the data using data processing software employing a risk assessment model. In some embodiments, the class of lipoprotein, such as HDL, is separated by electrophoresis into subclasses.

A system can include an instrument for reading or evaluating the test data and software for converting the data into diagnostic or risk assessment information. In some embodiments, a system includes a device for analyzing samples from a patient and obtaining patient data. In some embodiments, the device includes a symbology, such as a bar code, which is used to associate identifying information, such as intensity value, standard curves, patient information, reagent information and other such information, with the device. The reader in the system is optionally adapted to read the symbology.

Further, the systems include a decision system or systems, such as a risk assessment model, for evaluating the digitized data, and generating a risk score for cardiac disease or disorder. Optionally, an assessment of the data can be combined with other patient information, including documents and information in medical records. In some embodiments, all software and instrument components are included in a single package. Alternatively, the software can be contained in a remote computer so that the test data obtained at a point of care can be sent electronically to a processing center for evaluation. In some embodiments, the systems operate on site at the point of care, such as in a doctor's office, or remote therefrom.

In some embodiments, a system for determining a risk score for a cardiovascular disease or condition in a subject includes a processor programmed to extract one or more selected features from data representing a lipoprotein or subclasses thereof in a sample from the subject; and programmed to determine the risk score for the cardiovascular disease or condition from the extracted features using a risk assessment model. In some embodiments, the selected features are selected from the group consisting of first order difference of deviation from calibrator, first order difference, maximum range, minimum range, first order difference of maximum over deviation from calibrator, first order difference of minimum over deviation from calibrator, skewness, skewness of deviation from calibrator, volatility, first order difference of volatility, and combinations thereof. In some embodiments, the data representing subclasses of a lipoprotein is data from an electropherogram of the sample from the subject.

In other embodiments, a system for generating a risk assessment model includes a processor programmed to generate at least two features of data representing a lipoprotein or subclasses thereof from a set of case samples and from a set of control samples, wherein the set of case samples is obtained from case subjects with a known cardiac status and wherein the set of control samples is obtained from control subjects that are known to not have the cardiac status of the case subjects; generate at least two features that show differences when the data from the set of case samples is compared to data from the set of control samples to provide selected features; determine one or more functional relationships between the selected features and a risk label assigned to data from the set of case samples and a risk label assigned to data from the control samples; assign a rank to every functional relationship; and specify the functional relationship that has the highest rank as the risk assessment model. In some embodiments, the processor is further programmed to normalize the data of each of the case and control samples before generating at least two features.

Other aspects of the disclosure include a method for determining a risk score for a cardiovascular disease or condition in a subject comprising extracting one or more selected features from data representing a lipoprotein or subclasses thereof in a sample from the subject; and determining the risk score for the cardiovascular disease or condition from the extracted features using a risk assessment model.

Other aspects of the disclosure include methods and systems for generating a risk assessment model. In some embodiments, a method comprises generating at least two features of data representing lipoproteins or subclasses thereof from a set of case samples and from a set of control samples; selecting at least two features that show differences when the data from the set of case samples is compared to data from the set of control samples to provide selected features; determining one or more functional relationships between the selected features and a risk label assigned to the data from the set of case samples and a risk label assigned to the data from the set of control samples; assigning a rank to every functional relationship; and specifying the functional relationship that has the highest rank as the risk assessment algorithm.

In some embodiments, a system for creating a model for determining a risk score for a cardiovascular disease or condition comprises a memory for storing training data from a population of subjects, the training data representing HDL subclasses from case samples and control samples, a processor in data communication with the memory, the processor programmed to select at least two features from the data, to train an adaptive learning method to provide a functional relationship between the selected features and an assigned risk label to the case samples and control samples, to validate the functional relationship, and to generate a model that includes a functional relationship between data representing HDL subclasses and the assigned risk label to provide the risk score; and a storage medium for storing the model for use in analysis of data representing HDL subclasses from a test sample from a subject and to provide a risk score for the cardiovascular disease or condition for the subject.

### BRIEF DESCRIPTION OF THE FIGURES

FIG. 1 shows a flow diagram of an exemplary method for analysis of risk of cardiovascular disease.

FIG. 2 is a more detailed flow diagram of an exemplary method for analysis of risk of cardiovascular disease. FIG. 2 shows deployment of the model for risk assessment for determining a risk score for a subject with an unknown cardiac status.

FIG. 3 is a flow diagram of an exemplary method for how the model was derived from data obtained from samples of patients with a known medical condition.

FIG. 4 is a more detailed flow diagram of an exemplary method for how the model was derived from data obtained from samples of patients with a known medical condition.

FIG. 5A displays a representative electropherogram of serum HDL and subclasses thereof. The fitted curve and the bioanalyzer trace overlap. Also shown are peaks for HDL 2b, HDL2, and HDL3.

FIG. 5B displays a representative electropherogram of LDL separation. The first 2 groups of peaks in the electropherogram are HDL and a marker peak respectively. The third peak is LDL.

FIG. 5C displays a representative electropherogram of separation of LDL, HDL and Lp(a).

FIG. 5D display a representative electropherogram of HDL, VLDL, LDL, and Lp(a).

FIG. 6 shows the ROC curve using six features. The ROC has an area under the curve (AUC) of about 0.95.

### DETAILED DESCRIPTION

Before describing the present disclosure in detail, it is to be understood that this disclosure is not limited to specific compositions, method steps, or equipment, as such can vary. It is also to be understood that the terminology used herein is for the purpose of describing particular embodiments only, and is not intended to be limiting. Methods recited herein can be carried out in any order of the recited events that is logically possible, as well as the recited order of events. Furthermore, where a range of values is provided, it is understood that every intervening value, between the upper and lower limit of that range and any other stated or intervening value in that stated range is encompassed within the present disclosure. Also, it is contemplated that any optional feature of the disclosed variations described can be set forth and claimed independently, or in combination with any one or more of the features described herein.

Unless defined otherwise below, all technical and scientific terms used herein have the same meaning as commonly understood by one of ordinary skill in the art to which this disclosure belongs. Still, certain elements are defined herein for the sake of clarity.

All literature and similar materials cited in this application, including but not limited to patents, patent applications, articles, books, treatises, and internet web pages, regardless of the format of such literature and similar materials, are expressly incorporated by reference in their entirety for any purpose. In the event that one or more of the incorporated literature and similar materials differs from or contradicts this application, including but not limited to defined terms, term usage, described techniques, or the like, this application controls.

The publications discussed herein are provided solely for their disclosure prior to the filing date of the present application. Nothing herein is to be construed as an admission that the present disclosure is not entitled to antedate such publication by virtue of prior disclosure. Further, the dates of publication provided may be different from the actual publication dates, which may need to be independently confirmed.

It must be noted that, as used in this specification and the appended claims, the singular forms “a”, “an” and “the” include plural referents unless the context clearly dictates otherwise.

As used herein, an adaptive machine learning process refers to any system whereby data are used to generate a predictive solution.

It should be noted that the term “comprising” does not exclude other elements or features. Also elements described in association with different embodiments may be combined. It should also be noted that reference signs in the claims shall not be construed as limiting the scope of the claims.

The terms “determining”, “measuring”, “evaluating”, “assessing” and “assaying” are used interchangeably herein to refer to any form of measurement, and include determining if an element is present or not. These terms include both quantitative and/or qualitative determinations. Assessing may be relative or absolute. “Assessing the presence of” includes determining the amount of something present, as well as determining whether it is present or absent.

The terms “decision boundary” or “probability borders” refers to the boundaries for each of the classifications of the data. For example, probability borders or decision boundaries can be determined using the risk score for the case samples with the known cardiac status and the risk score for the control samples, and computing the confidence levels that these risk scores represent the true classifications. In some embodiments, the probability borders can be assigned by finding a balance between sensitivity and specificity.

As used herein, the “selected or “final model” includes a computer-based problem solving and decision-support system based on knowledge of its task and logical rules or procedures for using the knowledge.

As used herein, a “functional relationship” refers to a mathematical function that transforms the input data to an output.

As used herein, a “neural network”, or “neural net”, is a parallel computational model comprised of densely interconnected adaptive processing elements. In the neural network, the processing elements can be configured into an input layer, an output layer and hidden layers. Suitable neural networks are known to those of skill in this art.

As used herein, a “processing element”, which may also be known as a perceptron or an artificial neuron, is a computational unit which maps input data from a plurality of inputs into an output in accordance with a function.

As used herein, “point of care testing” refers to real time diagnostic testing that can be done in a rapid time frame so that the resulting test is performed faster than comparable tests that do not employ this system. In addition, with the method and devices provided herein, it can be performed on site, such as in a doctor's office, at a bedside, in a laboratory, emergency room or other such locales. Point of care includes, but is not limited to: emergency rooms, operating rooms, hospital laboratories and other clinical laboratories, doctor's offices, or in the field.

As used herein, a “rank” refers to a relative value assigned to a functional relationship between the selected features and the risk label assigned to the data from each of the case samples and the risk label assigned to each of the control samples. The rank can be determined by analyzing a number of factors including, but not limited to, complexity, input features, evidence for a combination of complexity and input features, and generalization estimates for combinations of input features and complexity. In some embodiments, the functional relationship with the highest rank is a functional relationship that has the most evidence, the lowest generalization error, and/or combinations thereof.

A “risk label” as used herein is a label assigned to data from sample that has a known cardiac disease or condition. The label can be relative risk label or a numeric label. In some embodiments, the data from the case subjects is labeled high risk as the subjects are known to have had a myocardial infarction. In some embodiments, the data from the control cases is labeled low risk as the subjects are known to not have had a myocardial infarction.

A “risk score” represents the probability that a subject will develop a cardiac disease or disorder based on the input data representing a lipoprotein or subclass thereof. The probability can be determined by risk assessment model as described herein.

By “sensitivity” as used herein refers to the level at which a method of the disclosure can accurately identify samples that have been confirmed as positive for cardiovascular disease (i.e., true positives). Thus, sensitivity is the proportion of disease positives that are test-positive. Sensitivity is calculated in a study by dividing the number of true positives by the sum of true positives and false negatives. In some embodiments, the sensitivity of the disclosed methods for the detection of cardiovascular disease can be at least about 70%, at least about 80%, or at least about 90, 91, 92, 93, 94, 95, 96, 97, 98, 99% or more.

As used herein, “specificity” refers to the level at which a method of the disclosure can accurately identify samples that have been confirmed as negative for cardiovascular disease (i.e., true negatives). That is, specificity is the proportion of disease negative that are test-negative. In a study, specificity is calculated by dividing the number of true negatives by the sum of true negatives and false positives. In some embodiments, the specificity of the present methods is at least about 70%, at least about 80%, or at least about 90, 91, 92, 93, 94, 95, 96, 97, 98, 99% or more.

The term “using” has its conventional meaning, and, as such, means employing, e.g., putting into service, a method or composition to attain an end. For example, if a program is used to create a file, a program is executed to make a file, the file usually being the output of the program. In another example, if a computer file is used, it is usually accessed, read, and the information stored in the file employed to attain an end. Similarly if a unique identifier, e.g., a barcode is used, the unique identifier is usually read to identify, for example, an object or file associated with the unique identifier.

As used herein, a “transfer function”, also known as a threshold function or an activation function, is a special functional relationship which creates a curve defining two or more distinct categories. Transfer functions may be linear or non-linear functions, including quadratic, polynomial, or sigmoid functions.

### Methods and Systems for Diagnosis or for Determining Cardiovascular Risk

The disclosure provides methods and systems for diagnosing and/or determining a risk score for cardiovascular disease based on information obtained about a class of lipoproteins from a sample from a subject. Methods and systems comprise separating a class of lipoproteins or subclasses thereof in a sample from a subject, analyzing the resulting data, and providing a diagnosis or risk assessment. In some embodiments, the methods include the steps of performing a separation of a class of lipoprotein into subclasses obtained from a sample, reading the data, and processing the data using data processing software employing a risk assessment model. In some embodiments, the lipoproteins are separated by electrophoresis. The present disclosure is based in part on the unexpected discovery that analyzing the data representing lipoproteins or subclasses thereof with a risk assessment model generated as described herein results in a more accurate prediction of risk based on a single lipoprotein or subclass thereof. The systems and methods as employed herein provide a risk score with lower false positive and false negatives than a risk score derived using a combination of factors or using other methods.

Systems and methods for medical diagnosis or risk assessment for a subject are provided. These systems and methods can be employed at a variety of locations including emergency rooms, operating rooms, hospital laboratories and other clinical laboratories, doctor's offices, in the field, or in any situation in which a rapid and accurate result is desired. The systems and methods process patient data, such as data representing separation of lipoproteins or subclasses thereof, and provide an indication of a medical condition or risk or absence thereof.

The information about a subject or a patient includes data from physical and biochemical tests, such as immunoassays, and from other procedures. In some embodiments, the test can be performed on a sample from a patient at the point of care and generates data that can be digitized. The signal is processed using software employing a system for converting the signal into data and applying a risk assessment model computation to the data, which can be used to aid in diagnosis of a medical condition, a determination of a risk score of cardiovascular disease, or to monitor treatment for a cardiac disease or disorder.

Some aspects of the disclosure provides systems and methods for diagnosing a cardiovascular disease and/or determining a risk score for a cardiovascular disease or condition in a subject, the methods comprising: extracting one or more selected features from data representing a lipoprotein or subclasses thereof in a sample from the subject; and determining the risk score for the cardiovascular disease or condition from the extracted features using a risk assessment model. The risk score can also be utilized in diagnosis of a cardiovascular disease and/or monitoring treatment of cardiovascular disease.

### Separating Lipoproteins

In some embodiments, data representing a class of lipoproteins from a sample from the subject is obtained by separation of lipoproteins or subclasses thereof. In some embodiments, data representing subclasses of lipoproteins from a sample from the subject is obtained from an electropherogram obtained by electrophoretic separation of a class of lipoprotein into subclasses. In some embodiments, lipoproteins are separated by electrophoretically using a micro-channel device, and the data are analyzed using an adaptive method such as a neural network.

Lipoproteins in a sample from a subject can be separated using a number of methods. “Separating” as used herein refers to the separation of substances of interest by their differing properties, such as electrophoretic mobility. In some embodiments, the class of lipoproteins is selected from the group of HDL, LDL, VLDL, Lp(a) and combinations thereof. Lipoprotein subclasses include without limitation HDL subclasses, LDL subclasses, Lp(a) subclasses and combinations thereof. In some embodiments, the subclass comprises HDL2b.

In some embodiments, the separation is conducted using a microfluidic device. Micro-channel chip electrophoresis can provide higher resolution, smaller sample volume sizes, shorter analysis times, and reduced sample handling over capillary electrophoresis or traditional gel electrophoresis. An example of this type of electrophoresis is described in U.S. Pat. No. 6,042,710, which is hereby incorporated herein by reference in its entirety. One of skill in the art can use known methods and reagents to increase or decrease the separation of the components from a sample.

Samples can be obtained from a variety of sources including blood, plasma, serum, urine, other body fluids, biopsy tissue, cells and tissues. The samples can be analyzed individually or in some embodiments, samples are pooled. In some embodiments, the sample, optionally, further comprises calibrators.

A set of case samples is obtained from a plurality of case subjects that have a known cardiac status, disease, or disorder (hereinafter referred to as case samples). In some embodiments, the case subjects are those that are known to have a cardiac disease or condition including, without limitation, myocardial infarction, atherosclerotic plaques, blockages in heart blood vessels, abnormal electrocardiogram, or acute coronary syndrome.

A set of control samples is obtained from a plurality of control subjects that also have a known but different cardiac status than that of the set of case subjects (hereinafter referred to as control samples). In some embodiments, the control samples are obtained from subjects that are known to not have the same cardiac status, disease or condition of the subjects that provide the case samples. In some embodiments, the subjects that provide the control samples are known, at the time of the sample, to not have had a cardiac disease or condition including, without limitation, myocardial infarction, atherosclerotic plaques, blockages in heart blood vessels, abnormal electrocardiogram, or acute coronary syndrome.

A number of different cardiac diseases or disorders can be analyzed depending on the medical history of the case subjects and the control subjects. In some embodiments, the cardiovascular disease or condition is selected from the group consisting of coronary heart disease, myocardial infarction, acute coronary syndrome, angina, atherosclerosis, and peripheral artery disease. In some embodiments, the set of case samples is obtained from case subjects known to have had a myocardial infarction and the set of control samples is obtained from subjects known to not have had a myocardial infarction.

According to some embodiments of the methods, a separation device is employed. The separation device comprises a separation channel. In some embodiments, the separation channel is adapted for separating lipoproteins or subclasses thereof electrophoretically, chromatographically or electrochromatographically. For example, the separation channel is adapted for separating lipoproteins or subclasses thereof by electrophoretic methods selected from the group consisting of capillary gel electrophoresis (CGE, including separation in entangled polymer solutions), SDS polyacrylamide electrophoresis (SDS-PAGE), capillary electrophoresis and micro-channel/microfluidic channel electrophoresis.

According to some embodiments, a separation device comprises a microfluidic chip. A microfluidic chip for performing an electrophoretic separation comprises a base substrate comprising a main surface, wherein a channel is formed in said main surface of said base substrate in at least one direction. The chip can comprise an element for applying an electrical field across a separation channel. According to some embodiments, the chip can comprise a material selected from the group consisting of glass, quartz, silica, silicon, and polymers.

A variety of manufacturing techniques are well known in the art for producing micro-fabricated channel systems. For example, where such devices utilize substrates commonly found in the semiconductor industry, manufacturing methods regularly employed in those industries are readily applicable, e.g. photolithography, wet chemical etching, chemical vapour deposition, sputtering, electroforming, etc. Similarly, methods of fabricating such devices in polymeric substrates are also readily available, including injection molding, embossing, laser ablation, LIGA techniques and the like. Other useful fabrication techniques include lamination or layering techniques, used to provide intermediate micro-scale structures to define elements of a particular micro-scale device.

In some embodiments, the capillary channels will have an internal cross-sectional dimension, e.g. width, depth, or diameter, of between about 1 μm and about 500 μm, or between about 10 μm to about 200 μm.

In some aspects, planar micro-fabricated devices employing multiple integrated micro-scale capillary channels can be used. Briefly, these planar micro-scale devices employ an integrated channel network fabricated into the surface of a planar substrate. A second substrate is overlaid on the surface of the first to cover and seal the channels, and thereby define the capillary channels. Examples of such planar capillary systems are described in U.S. Pat. No. 5,976,336 incorporated herein by reference in its entirety. A separation medium is employed in the micro-channels formed in the substrate to bring about the separation of sample components passing through the micro-channels under the influence of an electric field induced across the medium by the electrodes.

According to some embodiments, the separation device comprises a separation medium. A variety of polymer matrices can be used as a separation medium, including cross-linked, and/or gellable polymers. In some embodiments, non-crosslinked polymer solutions are used as the separation medium. In some embodiments, there are provided herein non-crosslinked polymer solutions which comprise polyacrylamide polymer. The polyacrylamide polymer can be a polydimethylacrylamide polymer solution or a derivative thereof, which may be neutral, positively charged or negatively charged. Non-crosslinked polymer solutions that are suitable for use in the presently described methods, compositions, and kits have been previously described for use in separation of nucleic acids by capillary electrophoresis, see, e.g., U.S. Pat. Nos. 5,264,101, 5,552,028, 5,567,292, and 5,948,227, each of which is hereby incorporated herein by reference. In some embodiments, the separation medium can comprise a hydrophilic polymer. Non-limiting examples of suitable hydrophilic polymers include polyacrylamide, polydimethylacrylamide, polyethylene oxide, polyvinyl pyrrolidone, methyl cellulose and derivatives, and polydimethylacrylamide.

There are no particular limits on the polymer which can be used to effect the separation, as long as suitable performance of the separation medium can be obtained. Suitable concentration of polymer, and suitable molecular weight of the polymer in the matrix, can be determined empirically. According to some embodiments, the matrix comprises polymers having a molecular weight less than about 10000 kDa. In some embodiments, the matrix comprises polymers having a molecular weight less than about 500 kDa. In some embodiments, the matrix comprises polymers having a molecular weight less than about 300 kDa. In some embodiments, the matrix comprises polymers having a molecular weight in the range of about 50 kDa to about 500 kDa. In some embodiments, the matrix comprises polymers having a molecular weight in the range of about 100 kDa to about 300 kDa. In some embodiments, the matrix comprises polymer having a molecular weight in the range of from 150 kDa to 250 kDa.

In some embodiments, the non-crosslinked polymer is present within the separation medium at a concentration of between about 0.01% and about 30% (w/v). Different polymer concentrations can be used depending upon the type of separation that is to be performed, e.g., the nature and/or size of the lipoproteins to be characterized, the size of the capillary channel in which the separation is being carried out, and the like. Suitable concentrations can be determined empirically. In some embodiments, the polymer is present in the separation medium at a concentration of from about 0.01% to about 20%, between about 0.01% and about 10%, between about 0.1% and about 10%, or between 1% and about 5%.

According to some embodiments, the method of separating can include applying reagents including but not limited to alignment dye, associative lipophilic dye, loading buffer, running buffer, calibration samples and other reagents for carrying out the separation.

Detergents incorporated into separation media can be selected from any of a number of detergents that have been described for use in electrophoretic separations. In some embodiments, anionic detergents can be used. Alkyl sulfate and alkyl sulfonate detergents can be used, non-limiting examples of which include sodium octadecyl sulfate, sodium dodecylsulfate (SDS) and sodium decylsulfate. Suitable concentrations can be determined empirically. In some embodiments, the separation medium comprises such a detergent at a concentration of between about 0.02% and about 0.15% or between about 0.03% and about 0.1% (w/v). In some embodiments, the separation medium comprises such a detergent at a concentration of between about 0.01 mM and about 1 mM, between about 0.1 mM and about 1 mM, or between about 0.1 mM and 0.3 mM. In some embodiments, a sample containing lipoproteins for which separation is desired can be combined with a detergent, which can be present in any suitable concentration. For example, it can be in an amount of from about 0.10 to about 0.20 mM, in an amount of from about 0.125 to about 0.175 mM, or in an amount of about 0.15 mM.

The buffering agent can be selected from any of a number of different buffering agents. Non-limiting examples of suitable buffers include tris, tris-glycine, HEPES, TAPS, MOPS, CAPS, MES, Tricine, Tris-Tricine, combinations of these, and the like. A separation according to methods of the present disclosure can be performed at a pH in the range of from 3 to 10, from about 5 to 8, from about 7 to about 8, at a pH in the range of from about 7.3 to about 7.7, or at pH of about 7.5. In some embodiments, when using a detergent at the above-described concentrations in a separation medium, the buffering agent can be provided at a concentration between about 10 mM and about 300 mM, for example.

Before a sample comprising a plurality of unknown lipoproteins is analyzed, the measurement set-up can, optionally, be calibrated using a calibration sample. The calibration sample can be selected from a large variety of different calibration samples comprising a set of compounds of different size such as, for example, SRM 1951b—Lipids in Frozen Human, Serum, Level 1 (NIST, Gaithersburg, Md., USA), Ultra HDL calibrator vial., 1 ml (Genzyme Diagnostics, West Malling Kent, ME, UK); Human HDL, 10 mg, Human LDL, 5 mg, Human Ox. LDL, 2 mg, Human Lp(a), 0.1 mg (all available at BTI, Biomedical Technologies, Inc., MA, USA); AutoHDL/LDL Calibrator, 3 ml; HDL Standard, 15 ml (both available at Eco-Scientific, Rope Walk, Thrupp, Stroud, UK), Lipid Control Levels 1, 2 and 3 (all available at Polymedco, Inc., Cortland Manor, N.Y., USA), Low total cholesterol, TCh @ 50 mg/dL, LRC LEVEL 1; Normal total cholesterol, TCh (165-180 mg/dL, TG<100 mg/dL, LRC LEVEL 2; Elevated total cholesterol, TCh @ 265, TG @ 230; LRC LEVEL 3; High Density Lipoprotein, HDL @ 50, LRC LEVEL 4 (all available at Solomon Park Research Laboratories, Kirkland, Wash., USA), and HDL Reference Pools ID 204 (TV (SD) 60.1 (0.7) mg/dL), ID 205 (TV (SD) 30.5 (0.8) mg/dL), ID 301 (TV (SD) 49.5 (1.2) mg/dL), ID 303 (TV (SD) 50.6 (1.4) mg/dL), ID 305 (TV (SD) 30.8 (0.8) mg/dL), ID 307 (TV (SD) 40.5 (0.9) mg/dL) (all available at Centers for Disease Control and Prevention Atlanta, Ga. 3034, USA; prepared according to the Lipid Standardization Program (LSP)).

In some embodiments, a calibrator is used to provide a lipoprotein or subclass thereof in order to use the electropherogram of the calibrator, for example, to analyze the data, to measure subclasses, and/or to measure migration times or profiles. In other embodiments, a quality control is employed in the systems and methods as described herein. Quality control samples may include a known quantity of a lipoprotein or subclass thereof that may be the same as, slightly higher, and/or lower than the amount expected in the samples. In some embodiments, the quality control sample is analyzed and if the results do not fit within the expected range for that quality control sample, then the results are labelled as discrepant and the user may then decide to not use results of samples from that same chip. If, for example, the quality control sample is outside the range expected for that sample by a small amount, the user may decide to use the data from the samples from the same chip even though the quality control samples may indicate that the results from that chip fall slightly outside the expected results. In some embodiments, the calibrator and/or the quality control sample comprise a plurality of HDL subclasses, LDL subclasses and/or Lp(a) subclasses of a known amount.

In some embodiments of the present disclosure, calibrators comprising species covalently labelled with fluorescence tags may be employed. When the species of the calibration sample are stimulated with incident light, the tags attached to the species emit fluorescence light. Calibration samples or “calibrators” comprising a marker that fluoresces at a first wavelength, and a set of labelled fragments that emit fluorescent light at a second wavelength may also be employed. In some embodiments, none of the species in a calibrator are covalently labelled with fluorescent tags, but are non-covalently associated with dyes by, for example, ionic interaction, hydrophobic interaction, and intercalation. In some embodiments, the calibrator is associated with an associative lipophilic dye as described herein, before or during application of the calibrator to the separation medium.

In some embodiments where the lipoproteins have negative charges under the conditions for separation, associative liphophilic dye(s), as described herein, can be of neutral or positive charge. In other embodiments where the lipoproteins under conditions for separation have positive charges, associative liphophilic dye(s), as described herein, can be of neutral or negative charge. Alignment dyes, as described below, can be of positive, neutral, or negative charge. Due to lipophilic properties of associative dye(s) as described herein, a selective labelling of lipoproteins can be achieved. In some embodiments, the associative lipophilic dye(s) as described herein are characterized in that they detectably bind to lipoproteins, such as HDL subclasses, during a separation procedure and do not detectably bind to albumin or to hemoglobin during such separation.

Non-limiting examples of suitable associative lipophilic dyes include 1,1′-dioctadecyl-3,3,3′,3′-tetramethylindocarbocyanine perchlorate (DiI), 3,3′-dioctadecyloxacarbocyanine perchlorate (DiO), 1,1′-dioctadecyl-3,3,3′1,3′1-tetramethylindodicarbocyanine perchlorate (DiD), Vybrant DiD, 1,1′-dioctadecyl-3,3,3′,3′-tetramethylindotricarbocyanine iodide (DiR), N-(4,4-difluoro-5,7-dimethyl-4-bora-3a,4a-diaza-s-indacene-3-pentanoyl)sphingosine (BODIPY® FL C5-ceramide), and polymethine dyes, such as, e.g., benzopylyrium polymethine DY-630-OH (Dyomics). In some embodiments, combinations of 2, 3, 4, or more of such dyes can be used.

In some embodiments, a combination of 1,1′-dioctadecyl-3,3,3′,3′-tetramethylindodicarbocyanine perchlorate (DiD) and N-(4,4-difluoro-5,7-dimethyl-4-bora-3a,4a-diaza-s-indacene-3-pentanoyl)sphingosine (BODIPY® FL C5-ceramide) can be used and gives enhanced sensitivity in HDL subclasses analysis as compared to the use of one dye.

In some embodiments, the present disclosure provides an associative lipophilic dye containing a polymethine. Polymethines are described in U.S. Pat. No. 6,750,346 which is incorporated herein by reference in its entirety.

Associative lipophilic dyes as described herein can be injected into a separation channel, such as a microchannel, together with the sample to be analyzed, or added before or after the sample has been injected. Associative lipophilic dyes can be contained in the separation medium.

An alignment dye can also be injected into a microchannel together with the sample. Alignment dyes can be selected that rapidly traverse the separation channel, and are used to align or normalize the migration times of the macromolecules under analysis. For example, the peak due to an alignment dye can be used as a “tₒ” value. An alignment dye can be hydrophilic and negatively charged. Non-limiting examples of suitable alignment dyes include Alexa 700 (InVitrogen) and Dyomic-676 (Dyomics, Germany).

Introduction of the separation medium into a capillary channel or micro-channel may be as simple as placing one end of the channel into contact with the medium and allowing the medium to wick into the channel. Alternatively, vacuum or pressure may be used to drive the medium solution into the capillary channel. In integrated channel systems such as those used in chip electrophoresis, the separation medium is typically placed into contact with a terminus of a common micro-channel, e.g. a reservoir disposed at the end of a separation channel, and slight pressure is applied to force the polymer into all of the integrated channels.

In some embodiments, there are provided methods which can be performed electrophoretically, and which can comprise the following steps: injecting the sample into a chip, wherein the chip comprises at least one well for receiving the sample, and a separation channel coupled to the at least one well and being adapted for separating different compounds; and applying an electric field across the channel to move the sample through the channel.

A sample containing lipoproteins for which separation is desired is placed in one end of the separation channel and a voltage gradient is applied along the length of the channel. As the sample components are electrokinetically transported down the length of the channel and through the medium disposed therein, those components are resolved. The separated components are then detected at a point along the length of the channel, typically near the terminus of the separation channel distal to the point at which the sample was introduced. In some embodiments, a quality control sample may be introduced first, and then followed by one or more samples introduced sequentially. In other embodiments, the one or more samples and quality control sample may be introduced in parallel depending on the configuration of the separation device. In other embodiments, optionally, a second quality control sample may be introduced after the samples. Optionally, a calibrator sample may also be introduced into the chip.

After the fluorescent peak pattern of the calibration sample has been acquired, a sample of interest can be analyzed. In some embodiments, in order to allow for an alignment with the calibration peak pattern, a certain concentration of an associative lipophilic dye and a certain concentration of the largest labelled calibrator fragment (such as, e.g., HDL subclasses) can be added to a sample of interest, followed by separation and analysis. In some embodiments, in order to allow for an alignment with the calibration peak pattern and between samples, an alignment dye can be added. Compounds of the sample of interest can be separated, and the sample bands obtained at the separation column's outlet can be analyzed.

Detection of separated lipoproteins or subclasses thereof can be carried out using a laser induced fluorescence (LIF) detection system. Such a detection system can be operated for detection of fluorescence of the associative lipophilic dye. Typically, such systems utilize a light source capable of directing light energy at the separation channel as the separated species are transported past. The light source typically produces light of an appropriate wavelength to activate the labelling group. Fluorescent light from the labelling group is then collected by appropriate optics, e.g. an objective lens, located above, below or adjacent the capillary channel, and the collected light is directed at a photometric detector, such as a photodiode or photomultiplier tube. The detector is typically coupled to a computer, which receives the data from the detector and records that data for subsequent storage and analysis.

In some embodiments, an associative lipophilic dye emits fluorescent light of a first wavelength, whereas the covalently labelled species of a calibration sample emits fluorescence light of a second wavelength, which is different from the first wavelength. Some of the available calibrators comprise two or more different fluorescence dyes adapted for emitting fluorescence light of two or more different wavelengths. Correspondingly, there exist fluorescence detection units adapted for simultaneously tracking fluorescence intensity at two or more wavelengths.

Typically, the electrophoretic trace of separated lipoprotein or subclasses thereof shows several peaks. The electropherograms can be divided into segments. Segments of the electropherograms can be determined, for example, based on time domains, the location of peaks of separated lipoprotein subclasses, molecular weights of the lipoproteins, and combinations thereof.

An electropherogram of a serum sample from a subject includes peaks corresponding to HDL, LDL, VLDL, and Lp(a). HDL is usually represented by several peaks representing HDL subclasses. An electropherogram of LDL is typically represented by one or more broad peaks. In some embodiments, the separated LDL subclasses are identified as small and dense, medium, and large and light. In some embodiments, the elution time of the broad LDL peak changes as the composition of LDL subclasses changes in the sample. For example, samples with a larger proportion of small dense LDL will have an earlier elution time than samples with a larger proportion of light large LDL. An electropherogram of Lp(a) usually has one or more broad peaks representing Lp(a) subclasses. In some embodiments, the elution time of the Lp(a) peak changes as the composition of the sample changes. For example, the Lp(a) elution time may be shifted depending on the proportion of Lp(a) subclasses with higher or lower molecular weight, and the charge of the subclasses.

In some embodiments, the separated classes and/or subclasses of the lipoproteins can be detected in the electropherogram. For example, the classes or subclasses can be distinguished by physical characteristics such as molecular weight, density, or elution time. Alternatively, each of the classes or subclasses can be differentially labeled with a detectable label and the signal from each class or subclass analyzed separately.

### Systems and Methods for Generating a Risk Assessment Model for use in Determination of a Cardiovascular Risk Score for a Subject

In some aspects of the disclosure, methods and systems are provided for generating a risk assessment model that can be used to generate a risk score for cardiovascular disease in a subject. In some embodiments, a method to generate the risk assessment model comprises: generating at least two features of the data representing separated lipoproteins or subclasses thereof from each of the case samples and from each of the control samples, wherein the case samples are obtained from subjects with a known cardiac status and wherein the control samples are obtained from subjects known to not have the same cardiac status as the case samples; selecting at least two features that show differences when the data from the case samples is compared to data from the control samples to provide selected features; determining one or more functional relationships between the selected features and a risk label assigned to the data from each of the case samples and assigned to the data from each of the control samples; assigning a rank to every functional relationship; and specifying the functional relationship that has the highest rank as the risk assessment model.

Optionally, the selected risk assessment model can be trained using the case samples and control samples using N-fold cross validation. This training allows for readjustment of the risk assessment model to increase the accuracy of the prediction and to select the decision boundaries.

In other embodiments, a method of selecting a risk assessment model to generate a risk score for a cardiovascular disease includes obtaining data about separated lipoprotein or subclasses thereof from a plurality of samples, wherein the plurality of samples comprise case samples and a control sample or control samples, and normalizing the data from each sample; generating and selecting one or more features (also referred to as signal characteristics) of the normalized data, wherein the selected features are those that are different between the case samples and control samples; selecting a model to generate the risk score for the cardiovascular disease using an adaptive learning method, wherein the input is normalized data from the case samples and control samples, wherein the model selected has a functional relationship between the selected features and a risk label assigned to the corresponding cardiac status for each sample; and storing the model on a computer readable medium for use in analysis of data representing lipoproteins or subclasses thereof from a test sample from a subject to provide the risk score for the subject.

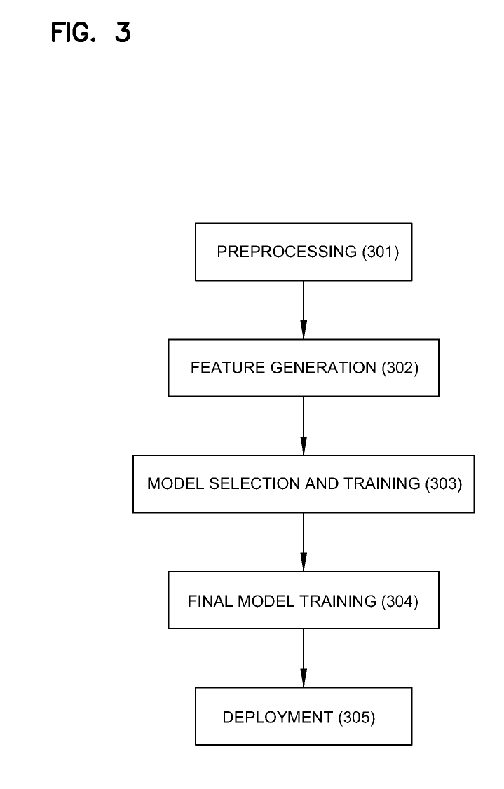

Referring now to FIG. 3, a flow chart of an exemplary method is provided. Data representing separated lipoproteins or subclasses thereof from a plurality of subjects is preprocessed (301) by normalizing the data to reduce noise and correct for any time shifts. The normalized data is then used to generate and select features. (302) Features are selected that provide for the largest difference between the data from case subjects and the data from controls. The features of the data from the case subjects and the control subjects are used to determine one or more functional relationships using, for example, an adaptive method. (303) A number of functional relationships are generated and each functional relationship is assigned a rank. The functional relationship with the highest rank is selected as the final model. The selected final model is optionally trained. (304) Once the trained final model is obtained and stored, for example, on a computer readable medium, it can then be deployed or used to analyze samples from a test subject with unknown cardiac status to provide a cardiovascular disease risk score. (305)

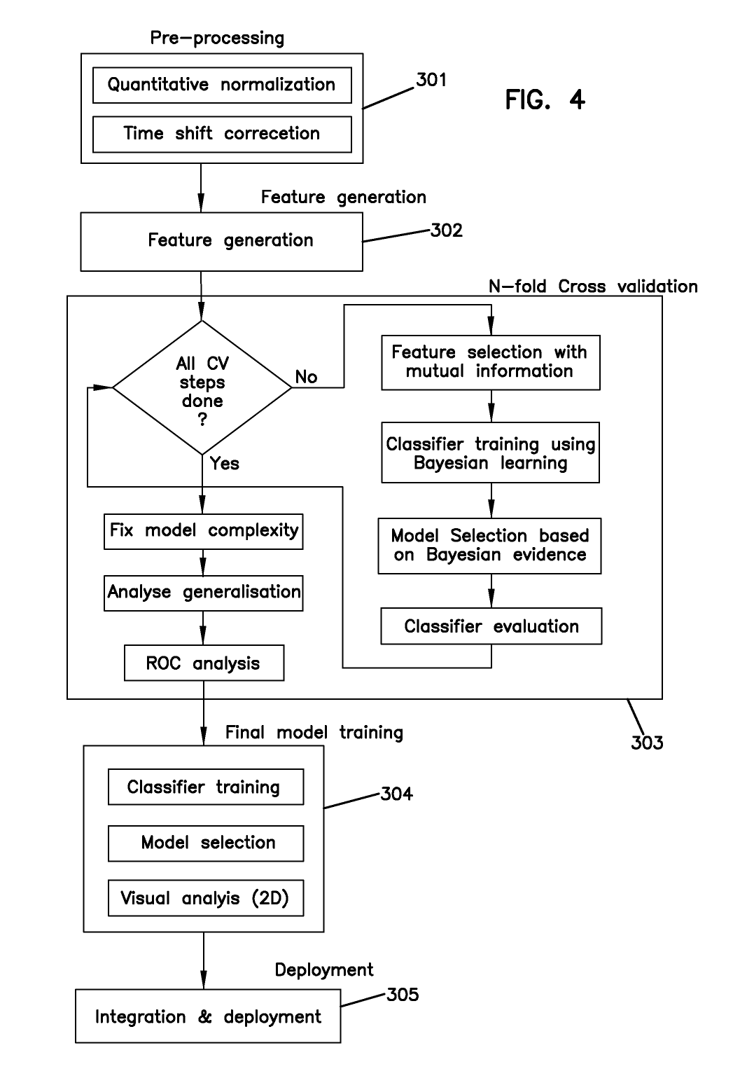

More specifically, an exemplary process of selecting a risk assessment model that can be used to generate a risk score for cardiovascular disease in a subject can be described by reference to FIG. 4.

The steps of the exemplary process of FIG. 4 comprise preprocessing of data representing separated lipoproteins or subclasses thereof from a plurality of subjects. (301) The data can be processed to remove noise by normalization. In some embodiments, normalization is quantitative and other embodiments, normalization is qualitative. In some embodiments, the time of elution of the peaks may shift, so the data, optionally, is corrected for time shift.

The normalized data is then analyzed to generate and select features. (302,303) The features, include without limitation, first order difference of deviation from calibrator, first order difference, maximum range, minimum range, first order difference of maximum over deviation from calibrator, first order difference of minimum over deviation from calibrator, skewness, skewness of deviation from calibrator, volatility, first order difference of volatility, volatility of deviation from calibrator and combinations thereof. Features are selected that provide mutual information and that provide for the largest difference between the case samples and the control samples.

In some embodiments, the disclosure provides computer-based systems that can be trained on data to classify the input data and then subsequently used with new input data to make decisions based on the training data. These systems include, but are not limited, expert systems, fuzzy logic, non-linear regression analysis, multivariate analysis, decision tree classifiers, Bayesian belief networks and, as exemplified herein, neural networks. In some embodiments, the selected features of the data from the samples obtained from case subjects and from control subjects are used to train a neural network. The classifiers are trained in N-fold crossvalidation (303), such as a 5-fold cross validation loop. Thus, each sample is in a validation group once and the likelihood of the sample belonging to the risk group is computed by the trained classifier. The N-fold cross validation results provide for classifier evaluation, analysis of generalization, and the receiver operator characteristic (ROC). A plurality of models is generated and a model is selected for varying numbers of input features and degrees of complexity (Schroeder et al., BMC Molecular Biology, 7(3) (2006)). Each model is assigned a ranking and the model with the highest rank is selected. The selected model is evaluated by measuring the area under the ROC curve (AUC) which provides a balanced measure of the generalization performance. An AUC of 1.0 means perfect assignment, whereas 0.5 would be random assignment.

Once the classifier complexity is selected, the classifier is trained using data representing separated lipoproteins or subclasses thereof from a plurality of case subjects and control subjects, and the final classification model is selected (304) and presented for visual analysis. The final model includes a computer-based problem solving and decision system based on knowledge of its task and logical rules or procedures for using the knowledge.

The model can be stored on a computer readable medium for use in providing a cardiovascular risk score for a subject with unknown cardiac status. (305) Probability borders for assigning patients to classifications are determined using the model. Probability borders can be determined by relationship to a numeric scale, such as 0-10 or based on relative risk levels based on a scale similar to that established by the National Cholesterol Education Project (NCEP) for coronary heart disease. The cardiovascular risk score can also be used to diagnose cardiovascular disease or monitor treatment of cardiovascular disease. In some embodiments, the method may further include: using the cardiac risk score with other patient information in a decision system to generate a medical diagnosis or risk assessment.

Normalization

In the systems and methods as described herein, the data representing lipoproteins or subclasses thereof is normalized. There are many different ways to normalize data depending on the source of noise in the data and the techniques used to generate the data. In some embodiments, the data representing separated lipoproteins or subclasses thereof is an electropherogram. In some embodiments, the data represents separated subclasses of HDL.

Electrophoretic traces may show shifts in the time domain up to several seconds, and signal strength may vary from chip to chip. Thus, in some embodiments, the signals are normalized on both axes before further analysis.

In some embodiments, signal strengths can be normalized by normalization of intrachip variation to eliminate drifts, and/or inter-chip normalization. In some embodiments, each of the signals can be normalized to a unity area measure. There may be a systematic drift in area values from the first calibrators to second calibrators on a single chip. In some embodiments, the drift is corrected by a linear transformation. A scale factor can be computed by:

a=(Area(SecondCalibrator)/Area(FirstCalibrator)) (1)

from the first calibrator to the second calibrator, and rescale each trace with channel number i by dividing through

((a−1)/12*i)+1 (2)

In some embodiments, inter-chip normalization can be performed by computing the mean m of the average area of the calibrators and calibrators for each separation device; setting a reference value (e.g. 1000) and computing a scale factor such that the average area of the calibrators and calibrators for each separation device equals this reference value; and using this factor to rescale each trace on this separation device. Making the average value of the calibrators and calibrators comparable, the noise on the individual area values for each sample is reduced to a minimum.

In some embodiments, a qualitative normalization can be conducted. For example, the values at each time point on the electrophoretic trace are compared to the total area value of the trace. In some embodiments, optionally a time shift correction can be applied to the data. There may be time shifts within the traces of one chip but also from chip to chip. A method for time shift correction includes determining a sensible time window for computing the correlation; choosing one signal (calibrator) as the reference signal; determining the maximally allowed shift s in x direction; computing the correlation for each shift between −s and s; and using the shift that maximizes the correlation between the sample and the reference calibrator.

Feature Generation and Selection

Electrophoresis traces are usually referred to as “electropherograms.” These traces represent plots of the signal intensities (e.g. lipoprotein subclasses) analyzed as functions of their migration times, which may, for example, be determined using the Agilent 2100 Bioanalyzer or other gel electrophoresis methods, including for example, capillary electrophoresis and chip electrophoresis approaches, as described above. The electrophoretic trace data can be used as a whole or segments of the tract can be selected based on appropriate matching criteria. The data points utilized are typically obtained from a segment of the electrophorectic trace.

The data points of electropherograms form the input into the systems and methods described herein. In some embodiments, a method or system comprises generating at least two features of the data representing lipoproteins or subclasses thereof from a set of case samples and from a set of control samples; to select at least two features that show differences when the data from the set of case samples is compared to data from the set of control samples to provide selected features. A few selected features or signal characteristics are extracted (generated and selected) from the electropherogram of each sample.

The set of case samples is obtained from a plurality of case subjects that have a known cardiac status, disease, or disorder. In some embodiments, the case subjects are those that are known to have a cardiac disease or condition including, without limitation, myocardial infarction, atherosclerotic plaques, blockages in heart blood vessels, abnormal electrocardiogram, or acute coronary syndrome.

The set of control samples is obtained from a plurality of control subjects that are known to not have the same cardiac, disease, or disorder that the case subjects have. In some embodiments, the set of control samples is obtained from subjects that have not had a cardiac disease or condition including, without limitation, myocardial infarction, atherosclerotic plaques, blockages in heart blood vessels, abnormal electrocardiogram, or acute coronary syndrome.

In some embodiments, the set of case samples is obtained from case subjects known to have a myocardial infarction and the set of control samples is obtained from subjects known to not have had a myocardial infarction.

The task of the feature generation step is to compute sensible characteristics of the signal traces that robustly highlight differences between the data representing each of the case samples and each of the control samples. In some embodiments, the following steps are included: compute typical characteristics, such as, higher moments of the distribution, mean, volatility, skewness, min-max values, spread; compute features that reflect the changing behaviour, such as, first order differences of both signal values and feature values; prefer simple characteristics over elaborate features; optimize time scales nᵢ of the feature transformations, i.e., the width of the sliding window for computing the feature. In general., the nᵢ is chosen to be as large as possible. At least two features (signal characteristics) are then generated. Features are selected that provide the maximum mutual information.

In some embodiments, features or signal characteristics of the data include typical features of electrophereograms. Other features are those that reflect the type of analyte separated and/or the profile of the separated analytes (eg., lipoproteins or subclasses thereof). In some embodiments, features are selected from the group consisting of first order difference of deviation from calibrator, first order difference, maximum range, minimum range, first order difference of maximum over deviation from calibrator, first order difference of minimum over deviation from calibrator, skewness, skewness of deviation from calibrator, volatility, first order difference of volatility, and combinations thereof. The data from the electropherograms is transformed into a representation of a feature or signal characteristic of that electropherogram. Measuring points can be sampled from the feature transformation in steps. In some embodiments, the measuring points can be sampled from time periods. In some embodiments, the steps are intervals of 0.25 seconds between 23 and 31 seconds. In some embodiments, the measuring points can be sampled based on the molecular weight of the separated lipoproteins or subclasses thereof. The measuring points provide the input data for the systems and methods described herein.

A risk label is assigned to the data from each of the case samples and each of the control samples. The data from the set of case samples represents data from subjects that have a known cardiac disease or conditions such as myocardial infarction. This data is labeled with either a relative risk, such as high risk, or numeric risk factor. The data from the set of control samples is obtained from subjects that have not had the same cardiac status, disease or condition of the case subjects at the time the sample is taken. The data from the set of control samples is assigned a risk label such as, low risk or a numeric risk value.

According to some embodiments of the disclosure, an iterative forward search is conducted by seeking the feature that yields the most information on the risk label. Under a second step, the next feature is selected that supplements the first feature's information content related to the risk label assigned to the data. Further steps of the iterative forward search arrange the features in a list, such that the information content of the last feature added to the list will increase the information content of those features already on the list.

At every step of this iterative forward search, the mutual information, i.e., the mutual information content of the combination of features and the risk label, is maximized. The mutual information software routine from the Generic Signal Profiler software package (GSP) supplied by the firm quantiom bioinformatics GmbH & Co. KG. may be employed for computing this mutual information. Information on that software and the company are available at quantiom.de

In some embodiments, the features are selected from the group consisting of first order difference of deviation from calibrator at 27.25 seconds, maximum at 25 seconds, first order difference at 25.5 seconds, skewness at 24.5 seconds, skewness of deviation from calibrator at 27 seconds, maximum over deviation from calibrator at 28.25 seconds, and combinations thereof.

Selecting a Risk Assessment Model

The systems and methods described herein provide a risk assessment model useful to diagnose and/or determine a risk for a cardiovascular disease or disorder in a subject, as well as monitor treatment of cardiovascular disease. In some embodiments, a method or system comprises determining one or more functional relationships between the selected features and the risk label assigned to the data from each of the case samples and from each of the control samples; assigning a rank to every functional relationship; and specifying the functional relationship that has the highest rank as the risk assessment model. The features and risk labels are determined from a set of case samples and control samples with known cardiac status, such as myocardial infarction or lack of myocardial infarction.

One or more functional relationships between the selected features and the risk label assigned to the data from the set of case samples and from the set of control samples are determined. The totality of features extracted from the measured data (e.g. lipoprotein electropherograms) and their associated risk labels, are used to determine the functional relationship between the cardiac risk labels and a suitable combination of features. The combination of features to be employed and the functional interrelation involved may be determined using, e.g., an adaptive method. In some embodiments, the functional relationship is a probability distribution relationship.

Different cardiovascular diseases or conditions can be analyzed or monitored including, without limitation, coronary heart disease, myocardial infarction, acute coronary syndrome, angina, atherosclerosis, and peripheral artery disease depending on the cardiovascular disease or disorder of the subjects that provide the first set of samples. In some embodiments, the case samples are obtained from subjects known to have had a myocardial infarction. In other embodiments, data from samples from subjects that have had, for example, angioplasty, heart bypass surgery, implantation of a stent, angina, or who have had a positive ultrasound scan for atherosclerotic plaques can be analyzed. The data from each of the samples from the set of case subjects is assigned a risk label based upon the presence of a known cardiac disease or conditions, such as the presence of a myocardial infarction. Different cardiac disease or conditions may be assigned different risk labels. In some embodiments, the risk label is a relative risk label such as high, medium or low risk. In other embodiments, the risk label is a numeric value, for example, a 10 on a scale of 0-10.

In some embodiments, the functional relationships between the selected features and the risk label are obtained using an adaptive learning method, such as a neural network. In some embodiments, as few features as possible are chosen as input to the neural network. Such a combination of features provide information on the risk label. In some embodiments, the model itself, i.e., the combination of features to be employed and the number of hidden neurons, can be determined by the steps that follow. Classifiers are trained for varying numbers of input features and degrees of complexity (Schroeder et al., cited supra, 2006). For example, the best functional interrelation is computed between the first feature of the list of Table 1, and the risk label. The complexity of the single-feature functional interrelation sought may be increased by successively adding hidden neurons. A rank may be computed for each such functional interrelation. As the number of hidden neurons increases, the rank of the interrelation found will initially increase and then decrease. The model may be insufficiently complex. However, overly complex models incorporate a surplus of parameters whose values can no longer be reliably set using the given database. The features and number of hidden neurons that yield the maximum rank are selected for the risk assessment model. Optionally, the rank may be increased by successively adding further features from the list until the best number of hidden neurons and the resultant rank for the combinations of features is obtained. The combination of features and associated number of hidden neurons for which the rank is maximized represent the model to be employed for the risk assessment model.

According to some embodiments of the disclosure, the ranks are determined using a Bayesian method. For example, a maximum a posteriori (MAP) approach might be employed. Under the MAP approach, the a posteriori probability is computed for a given model, based on training data. The a posteriori probability is used to rank the models. The higher the evidence or a posterior probability, the more likely the model is a true model for the observed data (Ragg, AI Communications 2002; Bishop, Neural Networks for Pattern Recognition, Oxford Press, 1995). Adjustment of the weighting factors of the neural network using the model chosen also employs the MAP approach. Further information on the MAP approach will be found in the relevant literature. The MAP approach can be implemented under the neural network model software routine from the aforementioned GSP software package, and can be employed in the case of the method and systems described herein. In some embodiments, evidence of a posterior probability was determined for from 1 to 6 features and a linear classifier and classifiers with complexity of 0 to 4 hidden neurons.

In some embodiments, the risk assessment model is validated. Validation protocols are used to confirm that all components of a system operate properly, and that the data received from the system is meaningful. For example, the final model can be validated by measuring the relationship between Receiver Operating Characteristics and the model evidence. Taking the likelihoods together, receiver operating characteristics (ROC) for risk assignment can be constructed. Measuring the area under the ROC curve (AUC) gives as a balanced measure of the generalization performance. An AUC of 1.0 means perfect assignment, whereas 0.5 would be random assignment. In some embodiments, a model is selected in which the evidence correlates well with the generalization measurement, i.e. the quality measure for the classifier is correct.

A risk assessment model that computes a risk score from a selected combination of features for a given electropherogram can thus be obtained. The computed risk score can be a decimal number or a relative label, and can be interpreted in the context of the assigned risk label. Probability borders for assigning a risk value to subjects can be determined by the receiver operator characteristic. In some embodiments, all test samples with p>0.8 are considered to correspond to a high risk. A border of 0.8 corresponds to a sensitivity of 0.8 and a specificity of almost 0.05. On the other side, all samples with p<0.2 are considered to correspond to a low risk. A border of 0.2 corresponds to a sensitivity of 0.985 and a specificity of 0.725.

In some embodiments, a risk assessment model is selected that provides for sensitivity and/or specificity of at least 70%. That is, specificity is the proportion of disease negative that are test-negative. Specificity is calculated by dividing the number of true negatives by the sum of true negatives and false positives. The specificity of the present methods is at least about 70%, at least about 80%, at least about 90, 91, 92, 93, 94, 95, 96, 97, 98, 99% or more. Sensitivity is the proportion of disease positives that are test-positive. Sensitivity is calculated in a study by dividing the number of true positives by the sum of true positives and false negatives. In some embodiments, the sensitivity of the disclosed methods for the detection of cardiovascular disease is at least about 70%, at least about 80%, or at least about 90, 91, 92, 93, 94, 95, 96, 97, 98, 99% or more.

In some embodiments, the risk assessment model as applied to data from separated lipoproteins or subclasses thereof provides for a decrease in the number of false positives and false negatives by about 25%, by about 30%, by about 35%, by about 40%, by about 50%, by about 55% and up to 100% when compared to risk assessment using a combination of the traditional risk assessment factors including age, body mass index, blood pressure, triglycerides, total cholesterol, LDL cholesterol, HDL cholesterol, Lipoprotein a, and fasting blood glucose.

After the final model is selected, in some embodiments, the model is stored on a computer readable medium for use in analysis of data representing lipoprotein subclasses from a test sample from a subject and to provide the risk score for the subject.

Methods and Systems for Diagnosing and/or Determining a Risk Score for Cardiac Disease or Disorder in a Subject with Unknown Cardiac Status

Once the final model is selected, it can be utilized to analyze a sample from a subject with unknown cardiac status. In some embodiments, the sample can be analyzed to provide a risk score for cardiovascular disease that can be used to guide treatment options and lifestyle changes for the subject. In some embodiments, the sample can be analyzed to provide a diagnosis of cardiovascular disease. In some embodiments, the risk score information is combined with other medical information about the subject in order to provide a risk assessment or diagnosis. Although additional medical information is not needed, as the analysis of lipoproteins or subclasses thereof provides a more accurate prediction than the combination of traditional risk factors. In some embodiments, the sample can be analyzed to monitor treatment for a cardiovascular disease.

As discussed above, in some embodiments, the model is stored on a computer readable medium. A system for diagnosing and/or determining a risk score for a cardiovascular disease or condition in a subject, includes a processor programmed to extract one or more selected features from data representing a separated class of lipoprotein or subclasses thereof in a sample from the subject; and to determine the risk score for the cardiovascular disease or condition from the extracted features using a risk assessment model.

In some embodiments, the sample is obtained from a subject and the lipoproteins or subclasses thereof are separated. Data representing the lipoprotein or subclasses thereof is, optionally, preprocessed. Preprocessing includes normalization of the data representing the lipoprotein or subclasses thereof and/or a time shift correction as described previously. In some embodiments, the lipoprotein is HDL, and the subclasses are separated by electrophoresis.

The features used to generate the risk assessment model can be extracted from the normalized data and analyzed using the risk assessment model. The risk assessment model provides a cardiac risk score for the subject based on the analysis of a single biological marker, such as the lipoprotein subclasses as described herein. The risk score is then presented or displayed to a user. The risk score can be used alone to guide recommendation for treatment, such as use of statins, or other lifestyle changes. The risk score can also be used in diagnosis of a cardiac disease or disorder and to guide recommendations for treatment or further diagnostic procedures. In some embodiments, the cardiac risk score may be combined with other patient information in order to provide a diagnosis or treatment recommendations. In some embodiments, the risk score can be used to monitor the treatment of a cardiac disease or status.

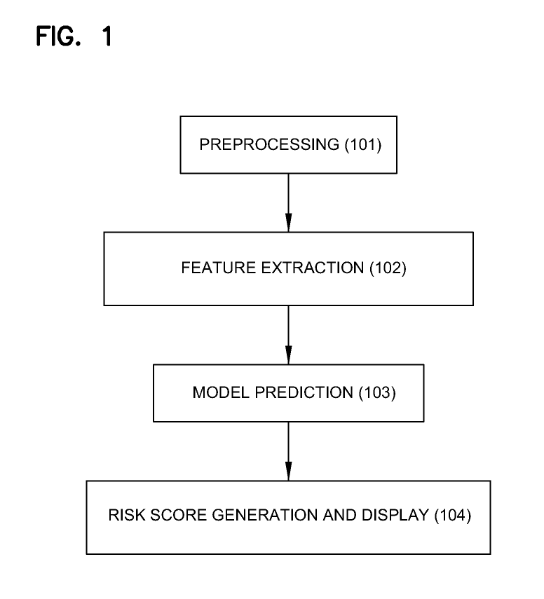

Referring now to FIG. 1, a flow diagram for an exemplary method for a method for diagnosing and/or determining a risk score for cardiovascular disease is provided. The method comprises preprocessing of data representing a lipoprotein or subclasses thereof obtained from a sample from a subject with unknown cardiac risk or status (101), extracting one or more selected features from the data (102), the selected features including those features used to generate the model; applying the risk assessment model to the extracted features to provide a risk score for the sample (103); and displaying the risk score to a user (104).

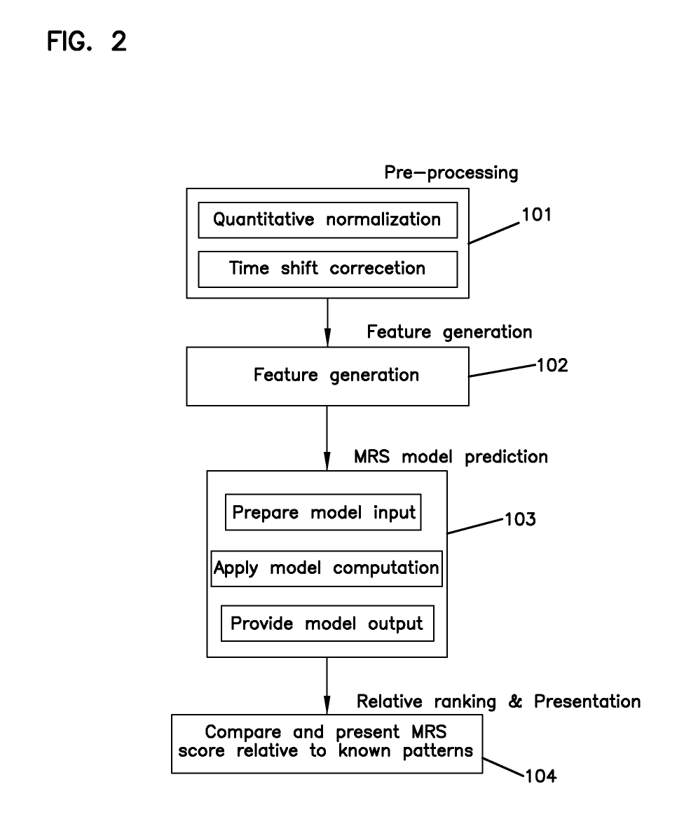

Referring now to FIG. 2, a flow diagram for another exemplary method for a method for diagnosing and/or determining a risk score for cardiovascular disease is provided. The method comprises preprocessing of data representing a lipoprotein or subclasses thereof obtained from a sample from a subject with unknown cardiac risk or status (101). In some embodiments, preprocessing includes, normalization of the data and correction of the data for time shift. One or more selected features are generated and extracted from the data (102), the selected features including those features used to generate the model. The risk assessment model is applied to the extracted features to provide a risk score for the sample (103). In some embodiments, the risk assessment model is applied by a method comprising preparing model input by extracting one or more selected features; applying the model computation; providing the model output as a risk score; comparing the risk score to other known patterns of data from subjects which is known to the system, such as the training data. The risk score then presented to a user. (104)

Systems for Implementing Methods as Described Herein

In some embodiments of the systems and methods described herein, a general purpose computing system can be utilized. An exemplary processing system provides a processor programmed to extract one or more selected features from data representing lipoproteins or subclasses thereof in a sample from the subject and to determine the risk score for the cardiovascular disease or condition from the extracted features using a risk assessment model. In some embodiments, the system comprises an input adapted to receive data representing lipoproteins or subclasses thereof and an output peripheral to display the risk score.

In some embodiments, the processing system comprises a memory for storing data from a population of subjects, the data representing lipoprotein or subclasses thereof from a set of case samples from a plurality of subjects, wherein each subject has a known cardiac status and a set of control samples from subjects with a known but different cardiac status; a processor in data communication with the memory, the processor programmed to select at least two features from the data, to provide a functional relationship between the selected features and the risk label assigned to the data from each of the case samples and the risk label assigned to each of the control samples, and to generate a model that includes a functional relationship between data representing a lipoprotein or subclasses thereof and the risk label assigned to that data to provide the risk score; and a storage medium for storing the model for use in analysis of data representing lipoprotein or subclasses thereof from a test sample from a subject and to provide a risk score for the cardiovascular disease or condition for the subject.

The processing system can be connected to a WAN/LAN, or other communications network, via network interface unit. Those of ordinary skill in the art will appreciate that network interface unit includes the necessary circuitry for connecting the processing system to a WAN/LAN, and is constructed for use with various communication protocols including the TCP/IP protocol. Typically, network interface unit is a card contained within the processing system.

The processing system may also include processing unit, video display adapter, and a mass memory, all connected via bus. The mass memory generally includes RAM 216, ROM 232, and one or more permanent mass storage devices, such as hard disk drive 228, a tape drive, CD-ROM/DVD-ROM drive 226, and/or a floppy disk drive. The mass memory stores operating system for controlling the operation of the processing system. It will be appreciated that this component may comprise a general purpose server operating system as is known to those of ordinary skill in the art, such as UNIX, LINUX, MAC OS, or Microsoft WINDOWS NT. Basic input/output system (“BIOS”) is also provided for controlling the low-level operation of processing system.

The mass memory as described above illustrates another type of computer-readable media, namely computer storage media. Computer storage media may include volatile and nonvolatile, removable and non-removable media implemented in any method or technology for storage of information, such as computer readable instructions, data structures, program modules or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data for providing processing and network development. More specifically, the mass memory stores applications including processing module, programs and other applications. Processing module includes computer executable instructions which, when executed by processing system performs the methods for determining a cardiac risk score as described herein.

The processing system also comprises input/output interface for communicating with external devices, such as a mouse, keyboard, scanner, or other input devices. Likewise, processing system may further comprise additional mass storage facilities such as CD-ROM/DVD-ROM drive and hard disk drive. Hard disk drive is utilized by processing system to store, among other things, application programs, databases, and program data used by processing module. The operation and implementation of these databases is well known to those skilled in the art.

In some embodiments, a neural network comprises a processing system comprising a set of processing modules. Networks are typically presented a set of input data, eg. electropherogram traces representing lipoproteins or subclasses thereof, which correspond to samples from subjects with known cardiac status or an assigned risk label. From these data values, the network of nodes “learns” a relationship between the input data and its corresponding cardiac status or assigned risk label. In this process, the functional relationship is estimated using the multi-dimensional network of nodes. This relationship is represented within a set of neural network coefficients for a particular topology of nodes.

The embodiments described herein can be implemented as logical operations performed by a computer. The logical operations of these various embodiments of the present disclosure can be implemented (1) as a sequence of computer implemented steps or program modules running on a computing system and/or (2) as interconnected machine modules or hardware logic within the computing system. The implementation is a matter of choice dependent on the performance requirements of the computing system implementing the disclosure. Accordingly, the logical operations making up the embodiments of the disclosure described herein can be variously referred to as operations, steps, or modules.

The following examples are intended to further illustrate some embodiments of the disclosure and are not intended to be limiting.

### EXAMPLES

### Example 1

Lipoprotein Separation and Analysis

A serum sample contains HDL, LDL, VLDL, and Lp(a). Each of these classes of lipoproteins was separated using electrophoresis. Different classes or subclasses of the lipoproteins can be distinguished based on physical characteristics such as elution times or molecular weight or by differential labeling.

### Methods

Microfluidics Gel Electrophoresis

All tests were carried out on the Agilent 2100 Bioanalyzer (Agilent, Waldbronn, Germany) using a newly developed HDL sub-fraction assay. In short, a linear polymer solution was used as the separation matrix. Serum samples, Calibrator and QC materials (Solomon Park Research Institute, Kirkland, Wash.), were diluted 1:50 in the presence of a lipophilic fluorescent dye and allowed to incubate for 5 to 15 minutes prior to analysis. Buffer wells of the microfluidics chips (Caliper Life Sciences, Hopkinton, Mass.) were filled with 10 μL of the polymer. The diluted Calibrators and QC materials were filled in the appropriate wells on the microfluidics chips and patient samples were added to the remaining 9 wells. Separation was carried out by starting the chip run, which executed a software script that applied currents and voltages in a pre-defined manner. Fluorescently stained lipoproteins are detected by laser induced fluorescence at 680 nm. After completion of the run, the chip was discarded and the electrodes were cleaned with a designated cleaning chip. The entire procedure was carried out in less than 1 hour.

Results

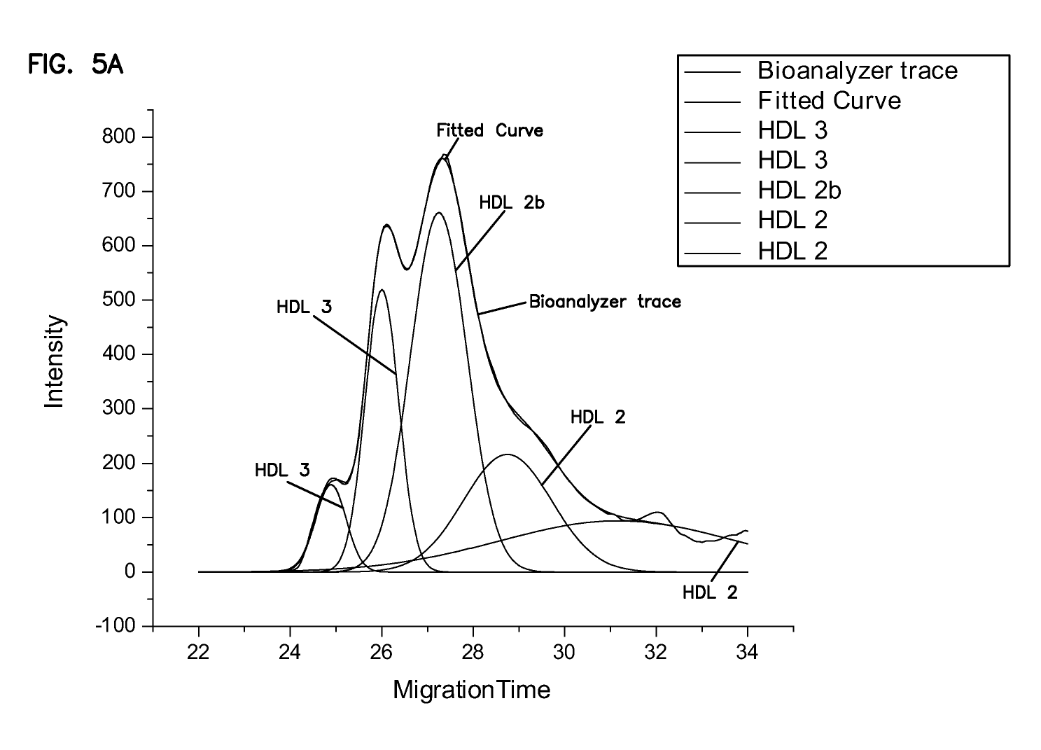

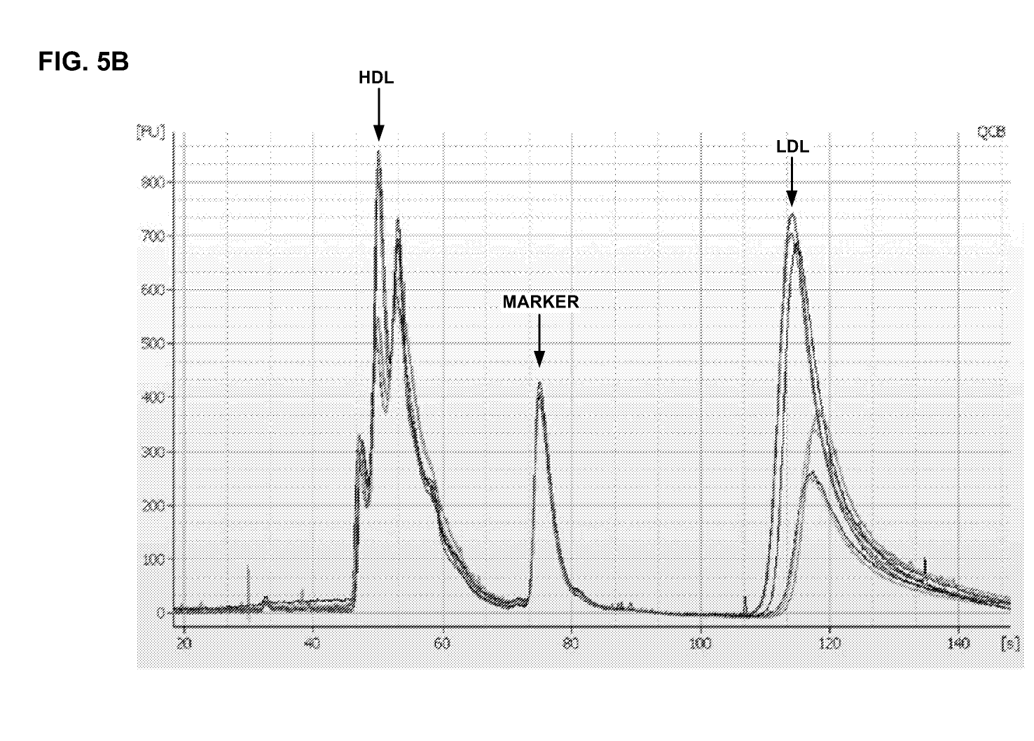

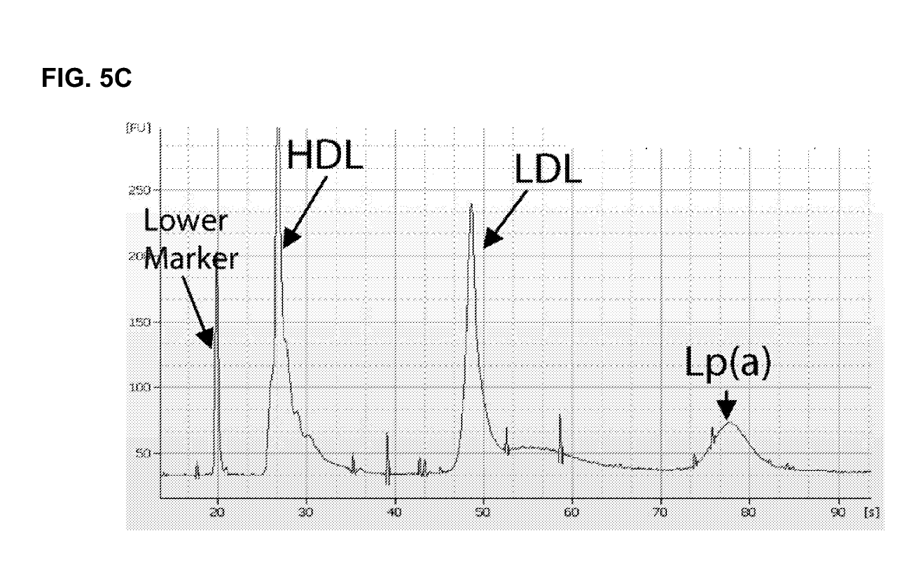

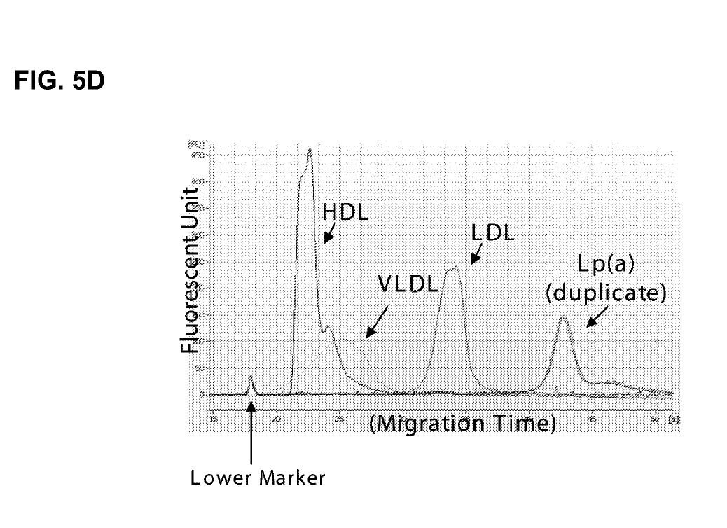

FIG. 5A displays a representative electropherogram of serum total HDL separated by the size-to-charge ratio by microfluidics gel electrophoresis. In-line markers (upper marker, UM and lower marker, LM) calibrate for migration time differences between individual samples and for sample injection bias (UM only). Most HDL samples display a profile with at least three distinct peaks and one to two shoulders. FIG. 5B displays a representative electropherogram showing LDL separation conducted in accord with methods of separation as described herein. LDL is shown as a broad peak. FIG. 5C displays a representative electropherogram of separation of LDL, HDL and Lp(a) using methods as described herein. Lp(a) is also shown as a broad peak. FIG. 5D display a representative electropherogram of HDL, VLDL, LDL, and L(p) separated using the methods as described herein.

Preparative ultracentrifugation (UC) suggests that the majority of HDL 3 particles(as defined by UC) are located in the first and second component curves, while most HDL 2 particles are located in the third through the fifth component curves of the HDL peaks as shown in FIG. 5A. Specifically, the predicted amount of HDL 2b from the third component curve was compared to the HDL-cholesterol content of the d<1.100 g/cm³ fraction from preparative ultracentrifugation. Their correlation of r=0.82, slope of 1.15, and intercept of 3.1 mg/dL is considered strong given that one method separates by density and the other by size to charge ratio. (data not shown) Based on this strong correlation, we decided to adopt the traditional nomenclature established with ultracentrifugation.

HDL cholesterol is calculated as the sum of the five component curves. HDL cholesterol areas of all samples were normalized using the area of the upper marker (FIG. 5A), which is contained in the dilution buffer solution. Each chip is calibrated using on-chip two-point calibration using a serum pool with a given amount of HDL cholesterol (51 mg/dL). Assay performance was verified though nine separate measurements of two serum pools (24 mg/dL and 58 mg/dL, respectively) at four different sites. For the low QC serum pool, inter-assay precision showed an average bias of −8.8% and an average CV of 7.1% as compared to the target value (24 mg/dL serum pool, Cholesterol Reference Method Laboratory Network—CRMLN—certified chemistry analyzer. The high QC serum pool (58 mg/dL serum pool, CRMLN certified analyzer) was measured on the microfluidics system with an average bias of −0.5% and an average CV of 5.2%. (data not shown).

As shown in FIG. 5B, 5C, or 5D HDL subclasses were separated from LDL subclasses and Lp(a).

LDL was separated from VLDL, HDL, and Lp(a). LDL appears as a broad peak. The time of elution of this broad peak will shift depending on the composition of LDL subclasses in the sample. Samples with a large proportion of small dense LDL subclass will elute earlier than samples with a large proportion of light large LDL subclass.

Lp(a) was also separated from HDL, VLDL, and LDL. Lp(a) appears as a broad peak. The elution time of this peak will also shift depending on the composition of the Lp(a) in the sample. Samples with a larger proportion of lower molecular weight forms of Lp(a) will elute earlier than those with Lp(a) with higher molecular weights. Charge of the forms of Lp(a) may also play a role in elution time.

### Example 2

A study was conducted to show the effectiveness and clinical utility of the current assay using samples from the Prospective Cardiovascular Munster (PROCAM) study, one of the world's largest prospective cardiovascular studies. This patient pool provides a source of samples to establish HDL subclasses, as measured on the Agilent 2100 Bioanalyzer, as an independent risk factor for cardiovascular disease.

Study Design

The clinical significance of the methodology was tested using a case-control study design that included 251 male MI survivors admitted in the vicinity of Munster, Germany and 252 male controls between the ages of 18 and 65 selected from the PROCAM cohort. Blood samples from MI survivors were taken within six hours after onset of clinical symptoms. For each case, one control sample from the PROCAM study was selected that was matched for age, HDL cholesterol, triglycerides and low-density lipoprotein (LDL) cholesterol. Additional information on body mass index (BMI), smoking habits and family history were collected from cases and used as covariates in relation to the existing survey data in controls. The large size of the PROCAM cohort facilitated the selection of an appropriate control for each MI case. All patient and control samples were collected between 2004 and 2006 and stored as sera at −80° C. All subjects provided informed consent and the study was approved by the appropriate institutional committee for the protection of human subjects.

Electrophoresis

Samples were analyzed as described in Example 1 and electrophoretic traces of the HDL subclasses were obtained for each sample. Briefly, all tests were carried out on the Agilent 2100 Bioanalyzer (Agilent, Waldbronn, Germany) using a HDL sub-fraction assay as described in Example 1. In short, a linear polymer solution was used as the separation matrix.

The electropherograms of the HDL subclasses from each sample were analyzed to generate a risk assessment model. Once the risk assessment model is generated it can be used to determine a risk score for a sample from a subject with an unknown cardiac status.

Normalization

The electropherograms traces were first normalized. There are a number of different ways that the data can be normalized. Normalization reduces noise in the signal and corrects for shifts in the time domain. Each trace was normalized to a reference value of, for example, 100. A time shift correction was also applied and is helpful in normalizing the data. The time shift correction reduces the fluctuations at a given time by maximizing the correlation of signals in a given time domain, for example, 1 second.

Normalization can be conducted both quantitatively and qualitatively. The data showed shifts in the time domain up to half a second for the calibrators. The signal strengths recorded for the calibrators also varies from chip to chip. Thus, the signals were normalized on both axes before further analyzing it. We applied two strategies for normalizing the signals strengths:

Strategy 1: apply a 2-step procedure. First perform an intra-chip normalization to eliminate drifts on the chip followed by an inter chip normalization, to make results from different chips comparable.

Strategy 2: normalize the signals to a unity area measure.

In strategy 1, we normalized the data both on measures that were intra chip and inter chip. For intra chip, there is a systematic drift in area values from the first calibrators to second calibrators. Based on this observation, it was assumed, that there was a linear trend in the data, which can be corrected by a linear transformation depending on the channel number as described below:

1. compute the scale factor a=(Area(SecondCalibrator)/Area(FirstCalibrator) from the first calibrator to the second calibrator

2. rescale each trace with channel number i by dividing through ((a−1)/12*i)+1

For inter chip variation, to make the results from different chips more comparable, an inter-chip normalization was performed:

1. compute the mean m of the average area of the calibrators and calibrators for each chip

2. set a reference value (e.g. 100) and compute a scale factor such that the average area of the calibrators and calibrators for each chip equals this reference value.

3. use this factor to rescale each trace on this chip.

The effects of the normalization procedure based on strategy 1 were analyzed by plotting the signal traces before and after normalization. Sample traces after inter-chip normalization show a reduced variation. (data not shown)

The qualitative normalization is much easier to handle. Qualitative normalization provides relative values at each time point compared to the total area value of the trace. Thus, the absolute values are lost for distinguishing between controls and cases. On the other hand, the strong noise on the area values between recordings is diminished. The qualitative normalization showed a low variance when comparing the calibrators of different chips. (data not shown) Looking at the samples again, we also observed, that signal traces from the cases group and the control group have a higher homogeneity. This is important for describing the differences in signal characteristics and in turn for deriving high performant classifiers.

Sample traces after qualitative normalization show a strongly reduced variation in signal strengths. The difference between risk group and control group is more visible. The qualitative normalization showed superior performance over the quantitative normalization for normalizing the signal strengths'. It was applied to all sample traces.

We also corrected the data for time shift. Comparing the times of occurrence of the first three peaks shows that there a shifts within the traces of one chip but also from chip to chip. The time shift is up to one second, which corresponds to 20 measuring points in the time domain. To determine a sensible time window, for computing the correlation, we choose two windows: From 22.5 to 25.5 seconds; and from 31 to 34 seconds. The latter window prevents shift in the signal. when the first peak is missing. We then chose one signal (calibrator) as the reference signal and determined the maximally allowed shift s in x direction. We used ±15 data points. The correlation for each shift between −s and s was computed and the shift that maximized the correlation between the sample and the reference calibrator was used. Other methods can be used to correct the data for time shift.

The time-shift correction was applied in turn, before the data was passed to the feature generation process step. The time shifts could be reduced strongly. (data not shown)

Feature Generation

The normalized data was used to generate and select features or signal characteristics. The task of the feature generation step is to compute sensible characteristics of the signal traces that robustly highlight differences between the cases group and the control group. The following steps were included: compute typical characteristics as higher moments of the distribution: mean, volatility, skewness, min-max values, spread; compute features that reflect the changing behaviour: first order differences of both signal values and feature values; prefer simple characteristics over elaborate features; optimize time scales nᵢ of the feature transformations, i.e., the width of the sliding window for computing the feature. In general, the nᵢ should be chosen as large as possible. At least two signal characteristics were then generated and selected. Signal characteristics were selected that provide the maximum mutual information.

Some of the signal characteristics show a clear difference between the cases group and the control group. (data not shown) From the visual inspection we concluded that the following features seem to be informative transformations:
Features based on the deviation from the chip calibrator
Volatility
Skewness (on a wider window)
Maximum in range
First order difference

Measuring points were sampled from the feature transformation in steps of 0.25 seconds between 23.5 seconds and 28.5 seconds. Thus we have for each transformation 21 data points. To select a combination of features we proceeded in the following way:

1. determine the transformation with the highest complementary information

2. determine the most informative region in this transformation

3. add this feature to the combination list, continue with 1, but skip this transformation for the next selection steps.

The following table contains the features of the selected combination. It shows the total mutual information of the combination.

TABLE 1
MI: Mutual Information (Information content).

| Feature | MI Combination |
|---|---|
| First order difference of | 0.70 |
| deviation from calibrator at | |
| 27.25 seconds | |
| Maximum at 25 seconds | 0.92 |
| First order difference at 25.5 | 1.09 |
| seconds | |
| Skewness at 24.5 seconds | 1.25 |
| Skewness of deviation from | 1.37 |
| calibrator at 27 seconds | |
| Max over deviation from | 1.44 |
| calibrator at 28.25 seconds | |

Model Training

The features were used to train neural networks classifiers with Bayesian learning. Following the estimation of Silverman, as described in Density Estimation for Statistics and Data Analysis (published by Chapman and Hall, 1986), for the amount of required data points per dimension, we chose to use up to 6 features for model training. Classifiers were trained for varying numbers of input features and degrees of complexity (Schroeder et al., cited supra, 2006). The list of features computed in the previous step was used to construct features spaces up to 6 dimensions.

The evidence computed in the Bayesian framework is a quality measure for the classifier. It is related to the posterior probability of a classifier. The higher the evidence, the more likely is the model a true model for the observed data (Ragg, AI Communications, 2002; Bishop, Neural Networks for Pattern Recognition, Oxford press, 1995) Evidence was determined for from 1 to 6 features and a linear classifier and classifiers with complexity of 0 to 4 hidden neurons.

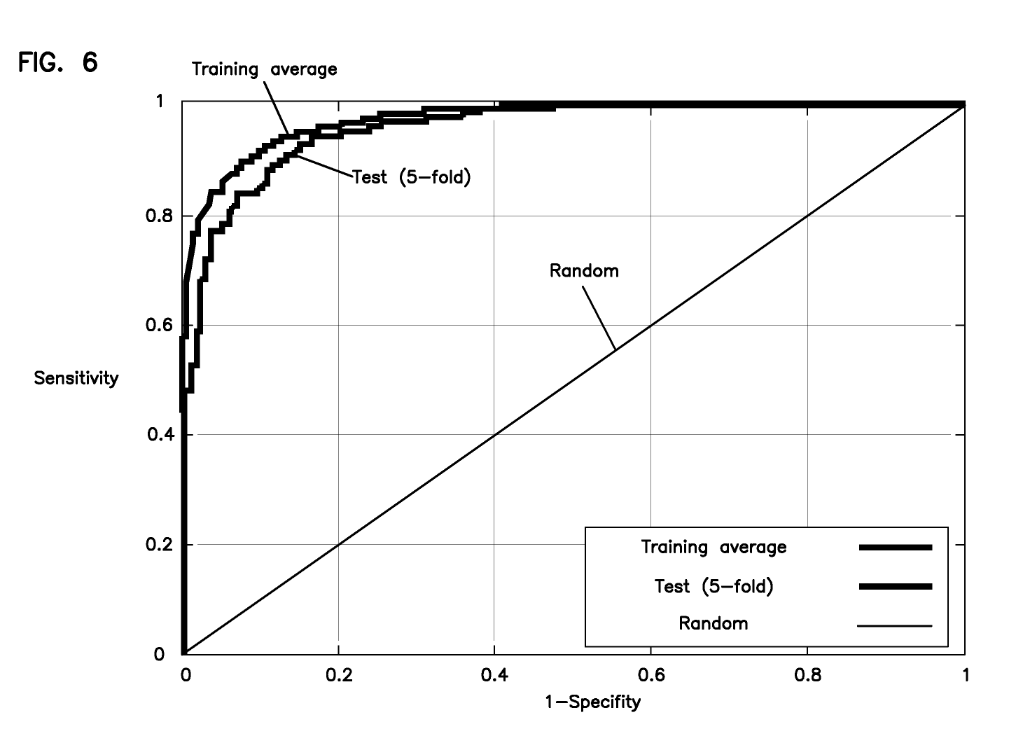

The classifiers were trained in a 5-fold cross validation loop. Thus, each patient was once in a validation group only once and his likelihood of belonging to the risk group was computed by the trained classifier. Taking the likelihoods together, we constructed a receiver operating characteristics (ROC) for risk assignment. Measuring the area under the ROC curve (AUC) gives as a balanced measure of the generalization performance. An AUC of 1.0 means perfect assignment, whereas 0.5 would be random assignment. FIG. 6 shows that with six features we reach an AUC value of about 0.95. Furthermore we can verify that the evidence correlates well with the generalization measurement, i.e. the quality measure for the classifier is correct.

We concluded that a log-linear classifier using 6 features has the highest evidence and was selected as most probable model topology.

Using the ROC analysis, probability borders for assigning patients to categories were determined. From the training results borders were derived that have a good relation from sensitivity to specificity. All samples with p>0.8 are considered to correspond to a high risk. A border of 0.8 corresponds to a sensitivity of 0.8 and a specificity of almost 0.05. On the other side, all samples with p<0.2 are considered to correspond to a low risk. A border of 0.2 corresponds to a sensitivity of 0.985 and a specificity of 0.725. Thus, we have large groups of patients which can be assigned to their risk group with high confidence. The medium risk group shows indifferent behaviour, where it is difficult to make a clear decision.

The number of false positives and/or false negatives was determined using the selected classifier. The number of false positives and negatives were decreased as compared to a combination of traditional risk factors or other means of data analysis. The number of false positive and/or false negatives as determined using other methods is:
traditional risk score calculated by standard methods (9 cardiovascular risk factors):
   FP:64, FN:48
traditional risk score+bioanalyzer deconvoluted results based on peak areas:
   FP:39, FN:45
risk score as described herein (risk assessment model):
   FP:29, FN:29.

When the false positives and negatives of the risk assessment model as described herein were compared to false positive or negatives of a traditional risk score a decrease of false positives of about 55% is seen and a decrease of false negatives of about 40% is seen. When the false positives and negatives of the risk assessment model as described herein are compared to traditional risk score combined with analysis of electrophoretic traces of separated lipoprotein subclasses by deconvolution of peak areas a decrease of false positives of about 25% is seen and a decrease of false negatives of about 35% is seen.

Applicants unexpectedly observed that analyzing the entire electrophoretic trace of separated HDL subclasses alone provides a more accurate prediction than the combination of traditional risk factors or analysis of separated HDL subclasses using deconvolution.

Those skilled in the art will recognize that many equivalents of the methods, systems and devices according the disclosure can be made by making insubstantial changes to the methods, systems and devices. The following claims are intended to encompass such equivalents.

We claim:

1. A system for determining a risk score for a cardiovascular disease or condition in a subject, comprising:
a processor programmed to extract one or more selected features from data representing a lipoprotein or subclasses thereof in a sample from the subject; and to determine the risk score for the cardiovascular disease or condition from the extracted features using a risk assessment model.

2. The system of claim 1, wherein the selected features are selected from the group consisting of first order difference of deviation from calibrator, first order difference, maximum range, minimum range, first order difference of maximum over deviation from calibrator, first order difference of minimum over deviation from calibrator, skewness, skewness of deviation from calibrator, volatility, first order difference of volatility, and combinations thereof.

3. The system of claim 1, wherein the data representing a lipoprotein or subclasses thereof is data from an electropherogram of the sample from the subject.

4. The system of claim 1, wherein the sample is selected from the group consisting of blood, serum, urine, biopsy tissue, tissue and cells.

5. The system of claim 1, wherein, the lipoprotein is selected from the group consisting of HDL, LDL, VLDL, and L(p) a.

6. The system of claim 5, wherein the lipoprotein comprises HDL2b.

7. The system of claim 3, wherein the processor is further programmed to normalize the data before extracting the features.

8. The system of claim 7, wherein the data is normalized by comparing the signal value at each time point of the electropherogram to the total area value of the electropherogram.

9. The system of claim 1, wherein the cardiovascular disease or condition is myocardial infarction.

10. A system for generating a risk assessment model comprising:
a processor programmed to
generate at least two features of data representing a lipoprotein or subclasses thereof from a set of case samples and from a set of control samples, wherein the set of case samples is obtained from case subjects with a known cardiac status and wherein the set of control samples is obtained from control subjects that are known to not have the cardiac status of the case subjects;
select at least two features that show differences when the data each of the case samples is compared to data from each of the control samples to provide selected features;
determine one or more functional relationships between the selected features and a risk label assigned to data from the case samples and a risk label assigned to the data from the control samples;
assign a rank to every functional relationship; and
specify the functional relationship that has the highest rank as the risk assessment model.

11. The system of claim 10, wherein the processor is further programmed to normalize the data of each of the case and control samples before generating at least two features.

12. The system of claim 10, wherein the processor is programmed to generate the features by computing the characteristics of the electropherogram, and determining the time scale.

13. The system of claim 10, wherein the features are selected from the group consisting of first order difference of deviation from calibrator, first order difference, maximum range, minimum range, first order difference of maximum over deviation from calibrator, first order difference of minimum over deviation from calibrator, skewness, skewness of deviation from calibrator, volatility, first order difference of volatility, volatility of deviation form calibrator, and combinations thereof.

14. The system of claim 10, wherein the processor is programmed to determine the functional relationship between one or more features and the risk label using an adaptive method.

15. The system of claim 14, wherein the adaptive method is a neural network.

16. The system of claim 15, wherein the processor is programmed to assign a rank to each of the functional relationships using a Bayesian method.

17. The system of claim 16, wherein the processor is programmed assign a rank to each of the functional relationships by determining the posterior probability of each relationship by training the one or more functional relationships for varying numbers of input features and degrees of complexity.

18. The system of claim 17, wherein the processor is further programmed to evaluate the risk assessment model by determining generalization error, the number of false positives, the number of false negatives or combinations thereof.

19. A method for determining a risk score for a cardiovascular disease or condition in a subject, the method comprising:
extracting one or more selected features from data representing a lipoprotein or subclasses thereof in a sample from the subject; and determining the risk score for the cardiovascular disease or condition from the extracted features using a risk assessment model.

20. A method for generating a risk assessment model comprising:
generating at least two features of data representing a lipoprotein or subclasses thereof from case samples and from control samples;
selecting at least two features that show differences when the data from the case samples is compared to data from the control samples to provide selected features;
determining one or more functional relationships between the selected features and a risk label assigned to the data from the case samples and a risk label assigned to data from the control samples;
assigning a rank to every functional relationship; and
specifying the functional relationship that has the highest rank as the risk assessment model.

21. The system of claim 1, further comprising:
an input in data communication with the processor and arranged to receive data representing a lipoprotein or subclasses thereof in the sample from the subject; and
an output peripheral in data communication with the processor for presenting the risk score.

22. A method of selecting a model to generate a risk score for a cardiovascular disease comprising:
a) obtaining data about separated HDL subclasses from a plurality of samples, wherein the plurality of samples comprise case samples and control samples, and normalizing the data from each sample;
(b) generating and selecting one or more features of the normalized data, wherein the features are selected that are different between the case samples and the control samples;
(c) selecting a model from a plurality of models by training an adaptive learning method using the normalized data from the case samples and the control samples, wherein the model selected has a functional relationship between the selected features and a corresponding risk label assigned to each sample; and
(d) storing the model on a computer readable medium for use in analysis of data representing HDL subclasses from a test sample from a subject with unknown cardiac status and to provide the risk score for the subject.

23. The method of claim 22, wherein the selected model provides a decreased amount of false negatives and false positives as compared to the plurality of models.

24. A system for creating a model for determining a risk score for a cardiovascular disease or condition, the system comprising:
a memory for storing training data from a population of subjects, the training data representing HDL subclasses from a sample from each subject, wherein each subject has a known cardiac status;
a processor in data communication with the memory, the processor programmed to select at least two features from the data, to train an adaptive learning method to provide a functional relationship between the selected features and an assigned risk label to the samples, to validate the functional relationship, and to generate an model that includes a functional relationship between data representing HDL subclasses and the assigned risk label to provide the risk score; and
a storage medium for storing the model for use in analysis of data representing HDL subclasses from a test sample from a subject and to provide a risk score for the cardiovascular disease or condition for the subject.
